(19) United States
(12) Patent Application Publication
(10) Pub. No.: US 2002/0086584 A1
(43) Pub. Date: Jul. 4, 2002

(54) Electrical connector having built-in electrical devices

(76) Inventor: Yu Min Liu, Taipei (TW)

Correspondence Address: Keith Kline, PRO-TECHTOR INTERNATIONAL SERVICES, 20775 Norada Court, Saratoga, CA, 95070-3018, US

(21) Appl. No.: 09/819,486

(22) Filed: Mar. 27, 2001

(30) Foreign Application Priority Data
Dec. 30, 2000 (TW) 89222849

(51) Int. Cl. H01R 13/66

(52) U.S. Cl. 439/620

(57) ABSTRACT

An electrical connector comprises a modular jack having an opening, at least one electrical means, a terminal module electrically coupled to the electrical means, the terminal module having a plurality of bent contact terminals each having a contact end, a plurality of vertical joint terminals each having a joint end, and a platform for fixing the contact terminals and the joint terminals, and a housing for enclosing the electrical means and the terminal module. The contact ends and the joint ends are projected above the platform for directly electrically coupling to the electrical means. This can improve the transmission quality by decreasing signal attenuation by eliminating unnecessary connection between the electrical means and the terminal module.

### FIELD OF THE INVENTION

The present invention relates to electrical connectors and more particularly to an electrical connector having built-in electrical devices with improved characteristics.

### BACKGROUND OF THE INVENTION

As technology progresses telecommunication and network devices have more advanced features. For example, it is usually required to install one or more electrical devices (e.g., transformer, filter, etc.) in an electrical connector for eliminating noise, thus obtaining a better transmission quality. This is particularly important in high frequency signal transmission. Conventionally, electrical devices are built in an electrical connector coupled to an electrical equipment through a line. This technique may be found in U.S. Pat. Nos. 5,989,069 and 6,010,367. Both disclosed an electrical connector having an electronic element welded to a circuit board prior to electrically contacting terminals of terminal modules with terminals of circuit board. However, the previous design suffered from a disadvantage. In detail, the transmission quality is not an optimum due to the provision of circuit board. This is because signal attenuation is significantly apparent through circuit board. Further, such electrical connectors are complex in construction, resulting in an increase in the manufacturing cost. Thus improvement exists.

### SUMMARY OF THE INVENTION

It is an object of the present invention to provide an electrical connector comprising a modular jack having an opening, at least one electrical means, a terminal module electrically coupled to the electrical means, the terminal module having a plurality of bent contact terminals each having a contact end, a plurality of vertical joint terminals each having a joint end, and a platform for fixing the contact terminals and the joint terminals, and a housing for enclosing the electrical means and the terminal module. The contact ends and the joint ends are projected above the platform for directly electrically coupling to the electrical means. This can improve the transmission quality by decreasing signal attenuation by eliminating unnecessary connection between the electrical means and the terminal module.

In one aspect of the present invention, the housing of the electrical connector is formed by an integrated circuit (IC) packing, an insert molding, or an assembling. This results in a reduction in the manufacturing cost.

The above and other objects, features and advantages of the present invention will become apparent from the following detailed description taken with the accompanying drawings.

### BRIEF DESCRIPTION OF THE DRAWINGS

FIG. 1 is an exploded perspective view of a first preferred embodiment of electrical connector having a built-in electrical device according to the invention;

FIG. 2 is an exploded perspective view of the FIG. 1 electrical connector and a modular jack for receiving the electrical connector;

FIG. 3 is a cross sectional view of the FIG. 1 electrical connector to show the interior features thereof; and

FIG. 4 is a cross sectional view of a second preferred embodiment of electrical connector having built-in electrical devices according to the invention.

### DETAILED DESCRIPTION OF THE PREFERRED EMBODIMENTS

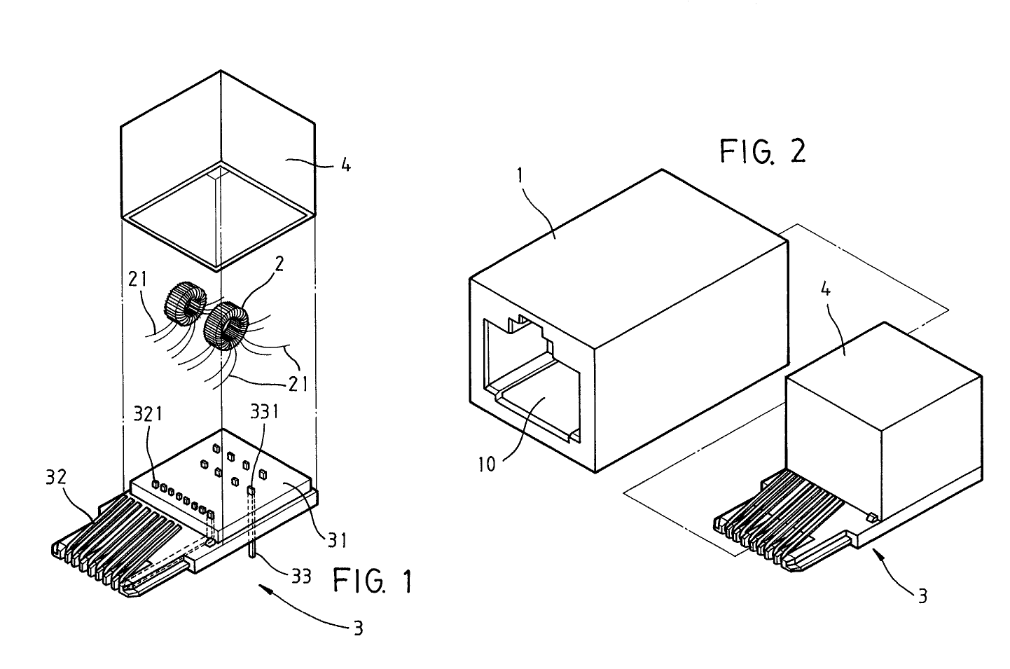

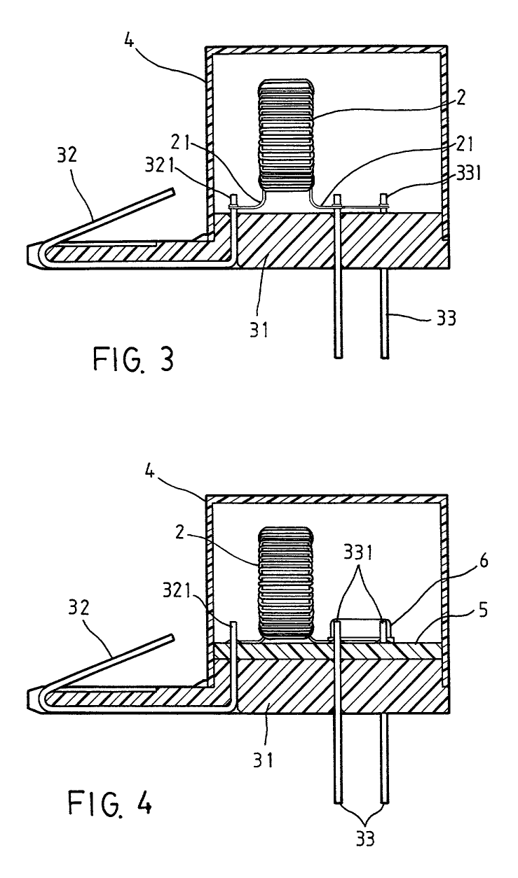

Referring to FIGS. 1 through 3, there is shown an electrical connector in accordance with the invention comprising a modular jack 1 having an opening 10, a built-in electrical device (e.g., transformer as shown) 2, and a terminal module 3 electrically coupled to the electrical device 2, terminal module 3 having a plurality of bent contact terminals 32, a plurality of vertical joint terminals 33, and a platform 31 for fixing the contact terminals 32 and the joint terminals 33. As shown in FIG. 2, each end 321 of contact terminal 32 (i.e., contact end) and each end 331 of joint terminal 33 (i.e., joint end) are slightly projected above platform 31. Hence, contact ends 321 and joint ends 331 may be directly electrically coupled to coils 21 of electrical device 2 without any form of connection means therebetween (FIG. 3). Then enclose above electrical device 2 and terminal module 3 by a housing 4 which is formed by integrated circuit (IC) packing, insert molding, assembling, or the like. Finally, insert housing 4 into modular jack 1 from the rear of the opening 10 of modular jack 1 to form a complete electrical connector.

Referring to FIG. 4, there is shown a second preferred embodiment of electrical connector having built-in electrical devices according to the invention. As shown, a circuit board 5 having a filter 6 is embedded on platform 31. Similarly, contact ends 321 of contact terminals 32 and joint ends 331 of joint terminals 33 may be electrically coupled to coils 21 of electrical device 2 and filter 6 through circuit board 5 respectively. Note that above connection may be effected by welding.

While the invention has been described by means of specific embodiments, numerous modifications and variations could be made thereto by those skilled in the art without departing from the scope and spirit of the invention set forth in the claims.

What is claimed is:

1. An electrical connector comprising:
a modular jack having an opening;
at least one electrical means;
a terminal module electrically coupled to said electrical means, said terminal module having a plurality of bent contact terminals each having a contact end, a plurality of vertical joint terminals each having a joint end, and a platform for fixing said contact terminals and said joint terminals; and
a housing for enclosing said electrical means and said terminal module;
wherein said contact ends and said joint ends are projected above said platform for directly electrically coupling to said electrical means.

2. The electrical connector of claim 1, wherein said housing is formed by an integrated circuit (IC) packing, an insert molding, or an assembling.

3. The electrical connector of claim 1, further comprising a circuit board having a filter embedded on said platform such that said contact ends and said joint ends are welded to said electrical means and said filter through said circuit board respectively.

4. The electrical connector of claim 2, further comprising a circuit board having a filter embedded on said platform such that said contact ends and said joint ends are welded to said electrical means and said filter through said circuit board respectively.
